(19) United States
(12) Patent Application Publication
(10) Pub. No.: US 2025/0232665 A1
(43) Pub. Date: Jul. 17, 2025

(54) MULTI-ROLE RF COMMUNICATION SYSTEM

(71) Applicant: General Electric Company, Schenectady, NY (US)

(72) Inventors: Gregory Alexander Natsui, Schenectady, NY (US); Guanghua Wang, Clifton Park, NY (US); Corey Bourassa, Mechanicville, NY (US); Michael J. Dell'Anno, Clifton Park, NY (US)

(21) Appl. No.: 18/411,682

(22) Filed: Jan. 12, 2024

(51) Int. Cl. G08C 17/02; B64D 27/10; B64F 5/60; H01P 3/16; H01Q 1/28

(52) U.S. Cl. CPC G08C 17/02; B64D 27/10; B64F 5/60; H01P 3/16; H01Q 1/28

(57) ABSTRACT

An RF communication system can include an RF transmitter, RF receiver, and a waveguide disposed between the RF transmitter and RF receiver. Each of the RF transmitter and RF receiver can include an RF antenna as well as RF electronics, the RF electronics useful to provide excitation signal to the RF antenna or to receive excitation from the RF antenna. The RF transmitter and/or RF receiver can also be a transceiver. In one form, the waveguide of the RF communication system acts as an electrical power bus. Alternatively and/or additionally, the waveguide of the RF communication system can also act as a structural member of a support structure. Alternatively and/or additionally, the waveguide of the RF communication system can also act as a heat transfer fluid circuit path. Alternatively and/or additionally, the waveguide of the RF communication system can also act as control path to convey a control signal.

### FIELD

The present disclosure relates to apparatus and methods related to an RF communication system structured to perform other roles, including non-RF roles.

### BACKGROUND

Vehicles, such as aircraft, can be platforms on which data can be collected for use within a process aboard the vehicle, or for further analysis. Other platforms can also be used to collect data, such as, but not limited to, test rigs used to perform tests on systems such as turbine engines. It is common for data collection to use wired or wireless techniques in which to transmit data for such control and/or analysis purposes. Furthermore, vehicles, such as aircraft, or stationary test rigs can be platforms on which RF communications are used, whether it be to aid in communicating with third parties (e.g., air traffic control), or in communicating on board the vehicle for purposes of control and/or analysis purposes.

Various components can be used to create an RF communication signal, transmit the RF communication signal, and receive the RF communication signal. RF transmitters and RF receivers can each include an antenna and associated electronics useful to provide an excitation signal to the antenna or receive an excitation signal from the antenna. A waveguide can also be used to aid in directing an RF communication signal between a transmitter and receiver. Each of the components of the RF communication system, when implemented on a vehicle such as an aircraft, represents a cost, both in terms of a financial cost as well as a weight cost. In some situations, the cost is understood and necessary, but other situations may counsel in favor of finding some type of savings.

Improvements to the configuration of RF communication systems would be useful in the art.

### BRIEF DESCRIPTION OF THE DRAWINGS

A full and enabling disclosure of the presently described technology, including the best mode thereof, directed to one of ordinary skill in the art, is set forth in the specification, which makes reference to the appended figures, in which:

FIG. 1 is depiction of a vehicle in the form of an aircraft.

FIG. 2 is an embodiment of a powerplant in the form of a gas turbine engine.

FIG. 3 is an embodiment of an RF communication system on board a vehicle in accordance with an exemplary embodiment of the present disclosure.

FIG. 4 is an embodiment of an RF communication system in accordance with another exemplary embodiment of the present disclosure.

FIG. 5 is an embodiment of a waveguide in accordance with another exemplary embodiment of the present disclosure.

FIG. 6 is an embodiment of a waveguide in accordance with another exemplary embodiment of the present disclosure.

FIG. 7 is an embodiment of a waveguide in accordance with another exemplary embodiment of the present disclosure.

FIG. 8a is an embodiment of a waveguide in accordance with another exemplary embodiment of the present disclosure.

FIG. 8b is an embodiment of a waveguide in accordance with another exemplary embodiment of the present disclosure.

FIG. 9 is an embodiment of a multi-purpose RF communication system in accordance with another exemplary embodiment of the present disclosure.

FIG. 10 is an embodiment of a multi-purpose RF communication system in accordance with another exemplary embodiment of the present disclosure.

FIG. 11 is an embodiment of a multi-purpose RF communication system in accordance with another exemplary embodiment of the present disclosure.

FIG. 12 is an embodiment of a multi-purpose RF communication system in accordance with another exemplary embodiment of the present disclosure.

FIG. 13 is an embodiment of an RF communication system in accordance with another exemplary embodiment of the present disclosure.

FIG. 14 is an embodiment of an RF communication system used to capture data of an engine in accordance with another exemplary embodiment of the present disclosure.

FIG. 15 is an embodiment of a computing system in accordance with another exemplary embodiment of the present disclosure.

FIG. 16 is an embodiment of a method for transmitting in accordance with another exemplary embodiment of the present disclosure.

FIG. 17 is an embodiment of a method for transmitting data in accordance with another exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

The present disclosure is generally related to RF communication systems that can be configured to perform multiple different roles. In general, an RF communication system includes an RF transmitter and RF receiver, and in embodiments disclosed herein, the RF communication system also includes a waveguide coupling the RF transmitter with the RF receiver. The RF transmitter can generally include an antenna and associated electronics useful to generate an excitation signal for the antenna. Similarly, the RF receiver can generally include an RF antenna and associated electronics that receive an excitation signal from the antenna. One or more components of the RF communication system, and in some forms specifically the waveguide, can perform additional functions beyond those associated with the RF communication system. For example, in one form, the RF communication system can be used in a heat exchange fluid flow circuit in which a working fluid, used to transfer heat from one location to another, is used in conjunction with the RF communication system. For example, an open interior of the waveguide can be used as a part of the heat exchange fluid flow circuit in which the working fluid is resident or traverses through the waveguide. The waveguide can alternatively and/or additionally act as a power bus and/or a data bus. Further still, the waveguide can alternatively and/or additionally act as a structural support member, such as in an engine.

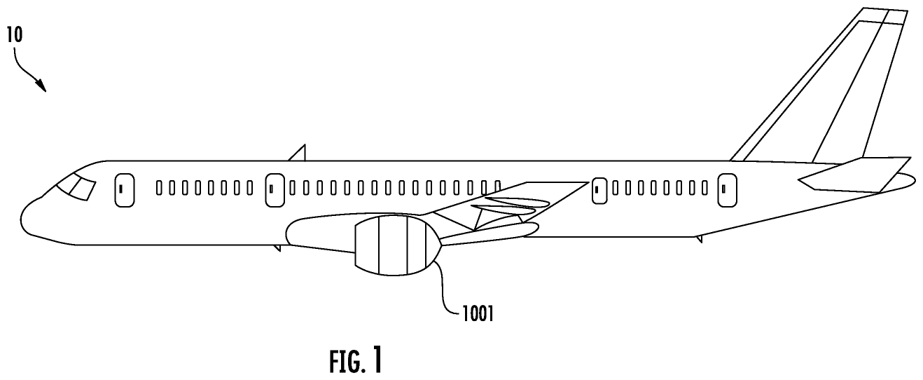

Referring now to the drawings, wherein identical numerals indicate the same elements throughout the figures, FIG. 1 provides an aircraft 10 capable of operating in a variety of operating conditions while using a powerplant 1001. The powerplant 1001 in the illustrated embodiment is in the form of a gas turbine engine, but other powerplants are also contemplated herein. For example, the powerplant 1001 can take the form of a piston engine, hybrid-electric engine, ramjet engine, scramjet engine, multi-mode engine, etc. The aircraft 10 depicted in FIG. 1 is illustrated as a fixed-wing aircraft, but other aircraft types are also contemplated, including rotorcraft, hovercraft, etc. As will be appreciated, the aircraft 10 can include a control effector 101 useful to provide control forces and moments to manipulate aircraft dynamics during operation of the aircraft 10. The control effector 101 can take a variety of forms, including a rudder (illustrated), elevator, aileron, speed brake, elevon, ruddervator, slat, flap, spoiler, ejector valve, engine nozzle actuator for thrust vectoring, etc.

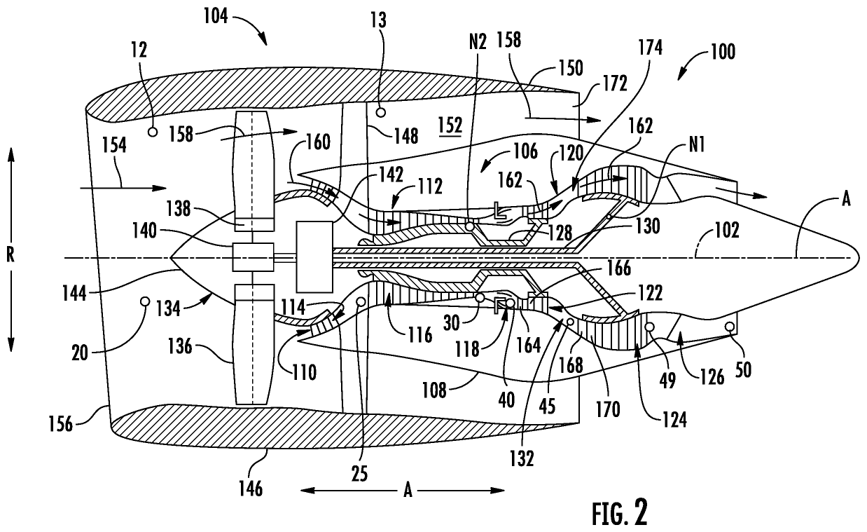

FIG. 2 provides a schematic cross-sectional view of a gas turbine engine 100 according to example embodiments of the present disclosure. For the embodiment of FIG. 2, the gas turbine engine 100 is an aeronautical, high-bypass turbofan jet engine configured to be mounted to or integral with a vehicle, such as the fixed-wing aircraft 10 of FIG. 1. The gas turbine engine 100 defines an axial direction A (extending parallel to or coaxial with an axial or longitudinal centerline 102 provided for reference), a radial direction R, and a circumferential direction (a direction extending three hundred sixty degrees (360°) around the longitudinal centerline 102).

The gas turbine engine 100 includes a fan section 104 and a core turbine engine 106 disposed downstream of the fan section 104. The example core turbine engine 106 depicted includes a substantially tubular outer casing 108 that defines an annular core inlet 110. The outer casing 108 encases, in a serial flow relationship, a compressor section 112 including a first, booster or low pressure (LP) compressor 114 and a second, high pressure (HP) compressor 116; a combustion section 118; a turbine section 120 including a first, HP turbine 122 and a second, LP turbine 124; and a jet exhaust nozzle section 126. An HP shaft 128 or spool drivingly connects the HP turbine 122 to the HP compressor 116. An LP shaft 130 or spool drivingly connects the LP turbine 124 to the LP compressor 114. The compressor section 112, combustion section 118, turbine section 120, and jet exhaust nozzle section 126 together define a core air flowpath 132 through the core turbine engine 106.

The fan section 104 includes a fan 134 having a plurality of fan blades 136 coupled to a disk 138 in a circumferentially spaced apart manner. The fan blades 136 extend outwardly from disk 138 generally along the radial direction R. The fan blades 136 and disk 138 are together rotatable about the longitudinal centerline 102 by the LP shaft 130 across a power gear box 142. The power gear box 142 includes a plurality of gears for stepping down the rotational speed of the LP shaft 130, e.g., for a more efficient rotational fan speed.

Referring still to FIG. 2, the disk 138 is covered by a rotatable spinner 144 aerodynamically contoured to promote an airflow through the plurality of fan blades 136. Additionally, the fan section 104 includes an annular fan casing 146 that circumferentially surrounds the fan 134 and/or at least a portion of the core turbine engine 106. Moreover, the fan casing 146 is supported relative to the core turbine engine 106 by a plurality of circumferentially spaced outlet guide vanes 148. Further, a downstream section 150 of the fan casing 146 extends over an outer portion of the core turbine engine 106 so as to define a bypass airflow passage 152 therebetween.

During operation of the gas turbine engine 100, a volume of air 154 enters the gas turbine engine 100 through an associated inlet 156 of the fan casing 146 and/or fan section 104. As the volume of air 154 passes across the fan blades 136, a first portion of the air 154, as indicated by arrows 158, is directed or routed into the bypass airflow passage 152 and a second portion of the air 154, as indicated by arrow 160, is directed or routed into core inlet 110 and downstream to the LP compressor 114 of the core turbine engine 106. The pressure of the second portion of air 160 is increased as it is routed through the HP compressor 116 and into the combustion section 118.

The compressed second portion of air 160 discharged from the compressor section 112 mixes with fuel and is burned within a combustor of the combustion section 118 to provide combustion gases 162. The combustion gases 162 are routed from the combustion section 118 along a hot gas path 174 to the HP turbine 122. At the HP turbine 122, a portion of thermal and/or kinetic energy from the combustion gases 162 is extracted via sequential stages of HP turbine stator vanes 164 that are coupled to the outer casing 108 and HP turbine rotor blades 166 that are coupled to the HP shaft 128 or spool, thus causing the HP shaft 128 or spool to rotate, which supports operation of the HP compressor 116. The combustion gases 162 are then routed through the LP turbine 124 where a second portion of thermal and kinetic energy is extracted from the combustion gases 162 via sequential stages of LP turbine stator vanes 168 that are coupled to the outer casing 108 and LP turbine rotor blades 170 that are coupled to the LP shaft 130 or spool, thus causing the LP shaft 130 or spool to rotate, which supports operation of the LP compressor 114 and/or rotation of the fan 134.

The combustion gases 162 are subsequently routed through the jet exhaust nozzle section 126 of the core turbine engine 106 to produce propulsive thrust. Simultaneously, the pressure of the first portion of air 158 is substantially increased as the first portion of air 158 is routed through the bypass airflow passage 152 before it is exhausted from a fan nozzle exhaust section 172 of the gas turbine engine 100, also producing propulsive thrust. The HP turbine 122, the LP turbine 124, and the jet exhaust nozzle section 126 at least partially define the hot gas path 174 for routing the combustion gases 162 through the core turbine engine 106.

With reference still to FIG. 2, it will be appreciated that the gas turbine engine 100 may be described with reference to certain stations, which may be stations set forth in SAE standard AS 755-D, for example. As shown, the stations can include, without limitation, a fan inlet primary airflow 20, a fan inlet secondary airflow 12, a fan outlet guide vane exit 13, an HP compressor inlet 25, an HP compressor discharge 30, an HP turbine inlet 40, an LP turbine inlet 45, an LP turbine discharge 49, and a turbine frame exit 50. Each station can have temperatures, pressures, mass flow rates, fuel flows, etc. associated with the particular station of the gas turbine engine 100. For example, a portion of air 154 at the LP turbine inlet 45 may have a particular temperature, pressure, and a mass flow. As further shown, the fan speed N1 is representative of the rotational speed of the LP shaft 130 or spool and the core speed N2 is representative of the rotation speed of the HP shaft 128 or spool. As will be explained herein, sensors can be positioned at these and/or other stations of the gas turbine engine 100 for sensing various operating parameters during operation.

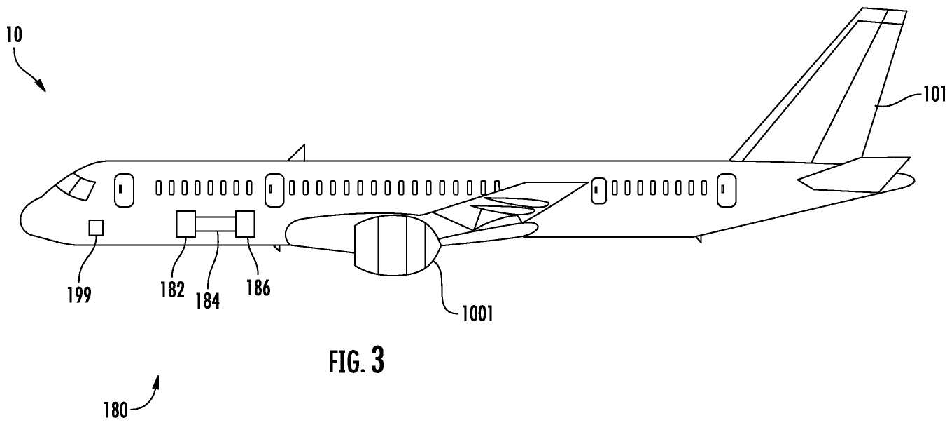

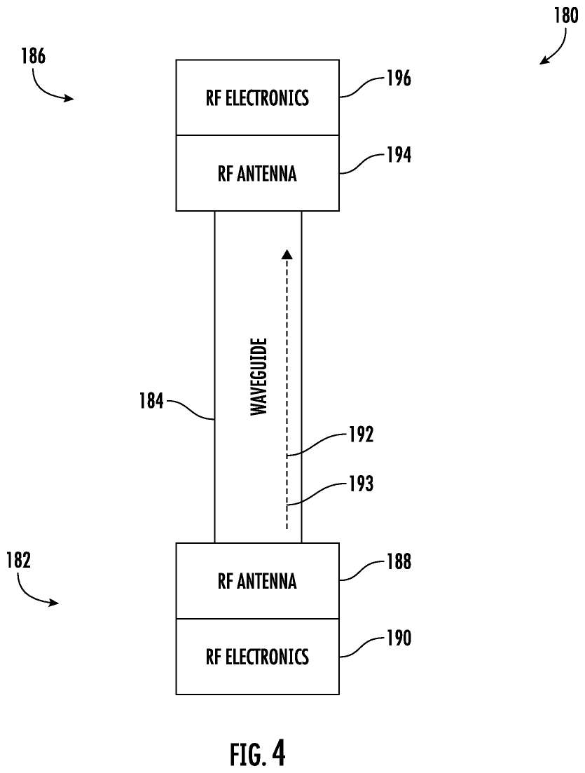

Turning now to FIGS. 3 and 4, the aircraft 10 can include a radiofrequency (RF) communication system 180 useful to facilitate reception and/or transmission of RF communications useful for aircraft operations. The RF communication system 180 includes RF transmitter 182, waveguide 184, and RF receiver 186 and can be used to communicate RF signals at any appropriate wavelength in which the RF transmitter 182, waveguide 184, and RF receiver 186 are configured to operate. In one non-limiting embodiment, the RF communication system 180 can be used to communicate at frequencies generally referred to as “5G” set by the 3^{rd} Generation Partnership Project (3GPP). In one form, communication wavelengths at “5G” frequencies can be at low band 5G (e.g., less than 1 GHz such as at 700 MHz-800 MHz), mid band 5G (e.g., 1 GHz-2.6 GHz and/or 3.5 GHz-6 GHz), and high band 5G (24 GHz-66 GHz). Thus, and for purposes of use herein unless specifically disclaimed, 5G can be considered anywhere from 700 MHz-66 GHz.

The RF transmitter 182, as illustrated in FIG. 4, can include an RF antenna 188 and RF electronics 190. The RF antenna 188 can be used to transmit an RF communication signal 192, via the waveguide 184, to the RF receiver 186. The RF antenna 188 can be any suitable shape and size, and be made of any suitable material, appropriate to the RF frequency used with the RF communication signal 192. The RF antenna 188 is used to conduct electromagnetic waves generated as a result of electrical current and/or voltage produced by the RF electronics 190. Upon generation of the electromagnetic waves generated as a result of excitation of the RF antenna 188 by the RF electronics 190, the electromagnetic waves radiate outwards from the RF antenna 188 for transmission to the RF receiver 186 constrained by waveguide 184.

As will be apparent from the figures, the present disclosure contemplates transmission of the RF communication signal 192 in a manner constrained by the waveguide, as opposed to omnidirectional manner as in some receivers, according to the configuration of the waveguide 184. Thus, the present disclosure contemplates a narrow region of reception of data transmitted with and through the waveguide 184 and received by the RF receiver 186 coupled to the waveguide 184.

The RF electronics 190 can include any suitable electronic circuit useful to generate an excitation signal for use with the RF antenna 188. In one form, the RF electronics 190 includes an electronic oscillator to generate an oscillating carrier wave, and a modulator which impresses a data 193 upon the carrier wave. In some forms the RF electronics 190 can also include an amplifier. As stated above, the RF electronics 190 can be used to generate an excitation voltage and/or current for use with the RF antenna 188 and subsequent generation of an RF communication signal.

Several embodiments of the instant disclosure contemplate that the RF transmitter 182 and RF receiver 186 are coupled to the waveguide 184 in such a manner that no relative motion exists between either the RF transmitter 182 or RF receiver 186. and the waveguide 184. In some embodiments herein, however, the RF transmitter 182 and RF receiver 186 are coupled to the waveguide 184 in such a manner that relative motion can exist between either the RF transmitter 182 or RF receiver 186. No limitation is hereby intended regarding the depiction in FIG. 4 illustrating a connection between the RF transmitter 182 and RF receiver 186.

The RF receiver 186, as illustrated in FIG. 4, can include an RF antenna 194 and RF electronics 196. The RF antenna 194 can be used to receive the RF communication signal 192 through the waveguide 184 from the RF transmitter 182. The RF antenna 194 can be any suitable shape and size, and be made of any suitable material, appropriate to the RF frequency used with the RF communication signal 192. The RF antenna 194 can generate an excitation voltage and/or current as a result of receiving the electromagnetic RF communication signal 192 transmitted by the RF antenna 188 via the waveguide 184.

The RF electronics 190 can include any suitable electronic circuit useful to extract the data 193 from the excitation voltage and/or current produced by the RF antenna 194 as a result of receiving the RF communication signal 192. In one form, the RF electronics 196 includes a demodulator which extracts the data 193 from the carrier wave of the RF communication signal.

In some embodiments herein, the RF transmitter 182 and the RF receiver 186 can alternatively be configured as a transceiver capable of both transmitting and receiving RF communication signals 192. In such embodiments, the RF transmitter 182 and RF receiver 186 can include appropriate RF electronics and RF antenna to enable both functions. For example, any given transceiver can include a modulator and demodulator, to set forth just one non-limiting example. Thus, no limitation is hereby intended regarding the RF transmitter 182 and RF receiver 186 unless specifically limited to the contrary. Any mention of RF transmitter, or simply transmitter, with respect to any component discussed herein includes an understanding that the component may alternatively and/or additionally function as an RF receiver, or simply receiver, as well. Likewise, any mention of RF receiver, or simply receiver, with respect to any component discussed herein includes an understanding that the component may alternatively and/or additionally function as an RF transmitter, or simply transmitter, as well.

FIG. 3 also illustrates a controller 199 that can be used to receive data and/or regulate various aircraft systems. In one form, the controller 199 can be an engine controller, such as, but not limited to, a Full Authority Digital Engine Controller (FADEC). The controller 199 can additionally and/or alternatively be an aircraft controller structured to generate control commands for one or more control effectors 101.

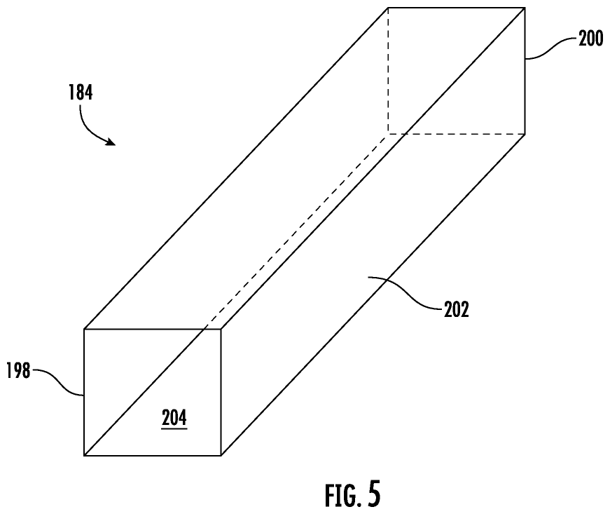

Turning now to FIGS. 5, with continued reference to FIGS. 3 and 4, the waveguide 184 is configured to carry the RF communication signal 192 between the RF antenna 188 and RF antenna 194. In one form, the waveguide 184 of the present disclosure extends between a proximal end 198 and a distal end 200, and includes an outer wall 202 extending around a periphery of the waveguide 184 to enclose an open interior 204. As discussed further below, the open interior can be occupied by any number of materials, fluids, gases, etc. The outer wall 202 can form any number of useful cross sectional shapes along the length of the waveguide 184, and can be formed through any number of manufacturing processes to enclose the open interior. In one form, the outer wall 202 has a uniform thickness around the periphery and between the proximal end 198 and distal end 200. As used herein, the term “open interior” is intended to convey the meaning that the waveguide 184 is not a monolithic component comprised of solid material throughout its interior, and, rather, that the outer wall 202 demarcates a space into which any number of dielectric materials, fluids, gases, etc. can occupy. For example, in one form, the open interior 204 is open at least at one end such that ambient fluids and/or gases (e.g., air) can intrude in the normal course of operation. In another embodiment discussed further herein, the open interior 204 can be coupled with a fluid flow path such that a dielectric liquid is permitted to occupy and/or flow through the open interior 204.

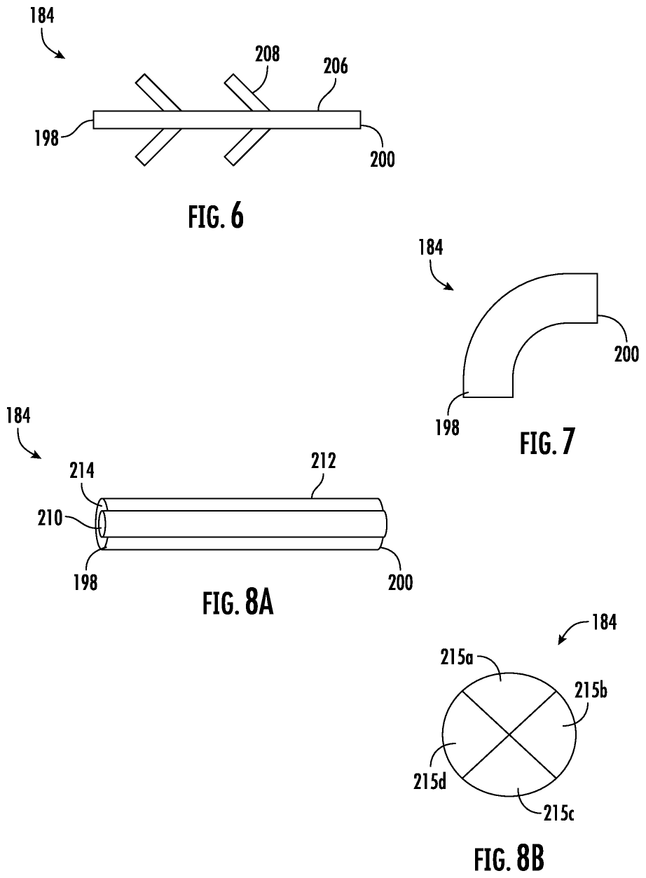

Referring to FIGS. 6-8, and with continued reference to FIG. 5, several different embodiments of the waveguide 184 are disclosed. The embodiment depicted in FIG. 6 includes a central body 206 that extends between proximal end 198 and distal end 200, with at least one branch 208 extending from the central body 206. Though the illustrated embodiment depicts four branches 208, some embodiments of the waveguide 184 can include fewer or greater numbers of branches 208. In those embodiments which include multiple branches 208, the branches 208 can be distributed symmetrically about the central body 206 as depicted in FIG. 6. Other embodiments, however, may include an asymmetric distribution of branches. Additionally and/or alternatively, some branches 208 may have other branches extending therefrom. Not all branches 208 may participate in the conveyance of the RF communication signal 192 between RF antenna 188 and RF antenna 194. For example, in one form, the central body 206 carries all, or predominately all, of the RF communication signal 192. Further, the branch 208 can be solid in one form, or can have an open interior, such as open interior 204, in another form. In those forms in which the branch 208 includes an open interior 204, such open interior can be coupled to the open interior 204 of the central body 206. Still further, the branch 208 can have the same cross sectional shape as the central body 206, but other shapes are also contemplated. To set forth a few non-limiting examples, the central body 206 may be rectangular in shape, while the branch 208 is circular. Yet still further, in those embodiments which include multiple branches 208, the branches 208 can be co-planar with one another. Other embodiments, however, can have branches 208 which are not co-planar with one or more other branches 208.

FIG. 7 depicts an embodiment of the waveguide 184 that is curved between the proximal end 198 and distal end 200. The embodiment of FIG. 6 can include a straight central body 206 and/or straight branch 208, where “straight” indicates a visual line of sight can be defined through the open interior 204. Any of the central body 206 and/or branch 208 can also be curved to a degree that a visual line of sight cannot be defined through the open interior 204. The waveguide 184 can take on a radius of curvature as depicted between proximal end 198 and distal end 200, and in which the curvature may have any given arc length suitable to any given application. Additionally and/or alternatively, the curvature of the waveguide 184 may have an inflection point. Still further, in some forms the curvature may vary along the length of the waveguide resulting in a shape not readily compared to basic geometric shapes such as an arc-length of a circle. Yet still further, the curvature between the proximal end 198 and distal end 200 can be a continuous curve, or can be a discontinuous curve. The embodiments related to FIG. 7 can include branches 208 depicted in FIG. 6.

FIG. 8a depicts a waveguide 184 that includes a first portion 210 disposed outside of and coaxial with a second portion 212. Each of first portion 210 and second portion 212 can include an open interior 204, in which an annular space 214 is defined between an inner surface of the first portion 210 and outer surface of the second portion 212. A dielectric fluid (gas or liquid) can be used within either or both of the annular space 214 or the open interior of first portion 210. Either, or both, of first portion 210 and second portion 212 can be used to conduct the RF communication signal 192 being sent between RF antenna 188 and RF antenna 194. Further, the either or both of waveguides 184 in FIGS. 6 and 7 can include a coaxial configuration as illustrated in FIG. 8a.

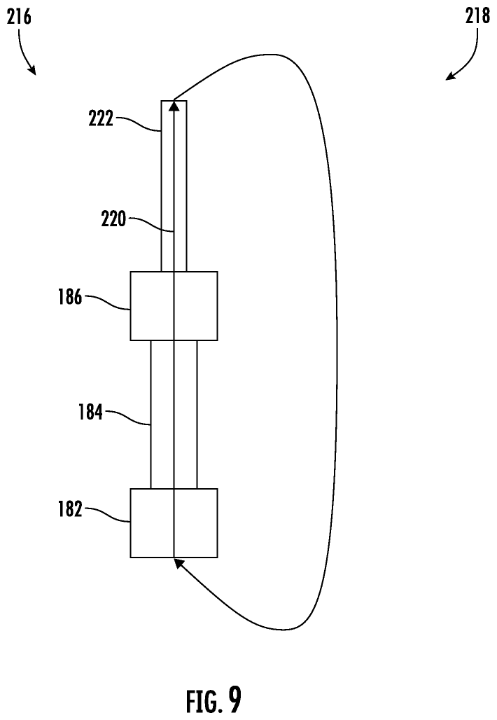

FIG. 8b depicts a waveguide 184 that includes a plurality of interior spaces 215a, 215b, 215c, and 215d. The illustrated embodiment depicts the interior spaces 215a, 215b, 215c, and 215d formed from a cross pattern of internal supports, but other shapes of internal supports and any number of other number of internal spaces is contemplated. Any one, or more, of the interior spaces 215a, 215b, 215c, and 215d, and internal supports used to form the interior spaces 215a, 215b, 215c, and 215d, can be used for purposes disclosed elsewhere herein. For example, interior space 215a can be used to convey working fluid as suggested in FIG. 9. Other uses are also contemplated.

Turning now to FIG. 9, an embodiment is illustrated of a multi-purpose RF communication system 216 which uses the waveguide 184 in a manner that is additional to its use as a waveguide between RF antennas associated with the RF transmitter 182 and RF receiver 186. The embodiment depicted in FIG. 9 illustrates one or more of the RF transmitter 182, waveguide 184, and RF receiver 186 integrated with a heat exchange fluid circuit 218. In one form, the heat exchange fluid circuit 218 includes a working fluid 220 generally used to receive heat from one location and move the heat to another location. Although the heat exchange fluid circuit 218 is depicted as a closed circuit in FIG. 9, other embodiments may include a circuit that is open (e.g., a circuit that flushes fluid to a reservoir or overboard but not otherwise recycled for further use). The heat exchange fluid circuit 218 can be incorporated into a variety of different heat transfer paths and/or cycles. In one form, the heat exchange fluid circuit 218 is part of an oil cooler circuit path. In another form, the heat exchange fluid circuit 218 is part of a refrigeration cycle. Regardless of the cycle or use that the working fluid is employed within, the heat exchange fluid circuit 218 can include one or more conduits 222 through which the working fluid traverses.

The heat exchange fluid circuit 218 therefore can be routed to move heat between a variety of locations of the aircraft 10, can be used in a variety of open circuits or closed loop cycles, and can use a variety of working fluid types. In many embodiments, the working fluid is contemplated as a dielectric fluid. The heat exchange fluid circuit 218 can include a flow path that traverses through the open interior 204 of the waveguide 184, and in some forms may also include flowing through or near the RF antenna 188 and/or RF antenna 194. With particular reference to the embodiment of the waveguide 184 depicted in FIGS. 8a-8b, the working fluid can be routed through either the annular space 214 or the open interior of first portion 210.

In one form, the waveguide 184 may act as a heat exchanger between the working fluid 220 traversing through the open interior 204 of the waveguide 184 and a second fluid (e.g., gas or liquid) resident on the exterior of the waveguide 184. In another form, the working fluid 220 of the heat exchange fluid circuit 218 may traverse the exterior of the waveguide 184, while the second fluid is resident or traversing through the open interior 204 of the waveguide 184. It will be appreciated that whether or not the working fluid 220 is interior to the waveguide 184 or exterior to the waveguide 184, the heat exchange fluid circuit 218 includes a conduit 222 through which the working fluid 220 traverses. It will be appreciated, therefore, given the description of the multi-purpose RF communication system 216 depicted in FIG. 9, that the waveguide 184 can act as any number of different types of heat exchangers used with any type of working fluid (e.g., an air/air heat exchanger, an air/oil heat exchanger, an oil/oil heat exchanger, a refrigeration heat exchanger as in a condenser or evaporator, etc.). With particular reference to the embodiment of the waveguide 184 depicted in FIGS. 8a-8b, the working fluid 220 can be routed through either the annular space 214 or the open interior of first portion 210, with the second fluid resident and/or flowing through the other of the annular space 214 or the open interior of first portion 210. Coaxial heat transfer between the working fluid 220 and second fluid when using the waveguide 184 of FIGS. 8a-8b can be in a co-flow relationship or a counter-flow relationship.

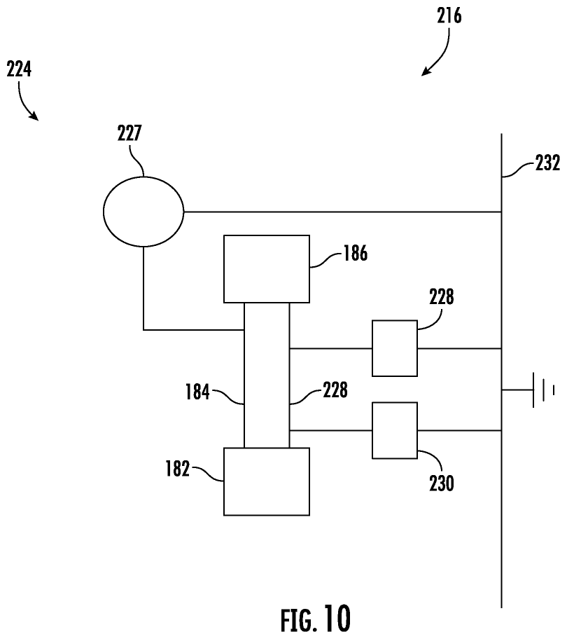

Turning now to FIG. 10, an embodiment is illustrated of a multi-purpose RF communication system 216 which uses the waveguide 184 in a manner that is additional to its use as a waveguide between RF antennas associated with the RF transmitter 182 and RF receiver 186. The embodiment depicted in FIG. 10 illustrates use of the waveguide 184 as a power bus 226 in an electrical power distribution system 224. The electrical power distribution system 224 can include a power generation source 227 useful to provide electrical power to the power bus 226, and from which electrical power can be conveyed to the first electrical component 228 and/or the second electrical component 230. As schematically depicted, the power generation source 227 creates a potential difference between the power bus 226 and an electrical ground 232. It will be appreciated that FIG. 10 is merely a schematic representation of the interconnections between the power generation source 227, the first electrical component 228, and the second electrical component 230. The drawing in FIG. 10 is not intended to imply the location of physical connection of the power generation source 227 or the first electrical component 228 and the second electrical component 230. In one nonlimiting embodiment, the waveguide 184 acts as a support structure onto which is mounted electric cabling. In such an embodiment, the waveguide 184 can include a channel formed on an interior or exterior face into which the electric cabling is placed.

The power generation source 227 can take a variety of forms, including an electric generator powered by mechanical power from, for example, the powerplant 1001. The power generation source 227 can also take other forms that are separate from, or driven by, the powerplant 1001. To set forth just a few non-limiting examples, the power generation source 227 can include a piezo-electric power source (powered by, for example, vibrations or movement of the aircraft 10), thermo-electric power source (powered by, for example, a heat difference such as can be realized using the waveguide 184 as a heat exchanger as in FIG. 9), or an electromagnetic power source (powered by, for example, microwave or laser energy).

Electric power delivered to the power bus 226 by the power generation source 227 can be provided to the first electrical component 228 and/or the second electrical component 230 through wired connection as depicted, but in some forms, power can be transmitted wirelessly (e.g., via a microwave generator driven by power from the power bus 226). It will be appreciated that the first electrical component 228 and the second electrical component 230 can be configured to be parallel or series connection. Further, the first electrical component 228 and the second electrical component 230 can represent a discrete electrical component (e.g., a simple resistor), can represent a larger electric circuit (e.g., an LED with electric drive circuitry), or can represent a larger electric system (e.g., an inertial navigation system). Thus, use of the term “component” is intended to encompass a broad variety of electrical driven devices.

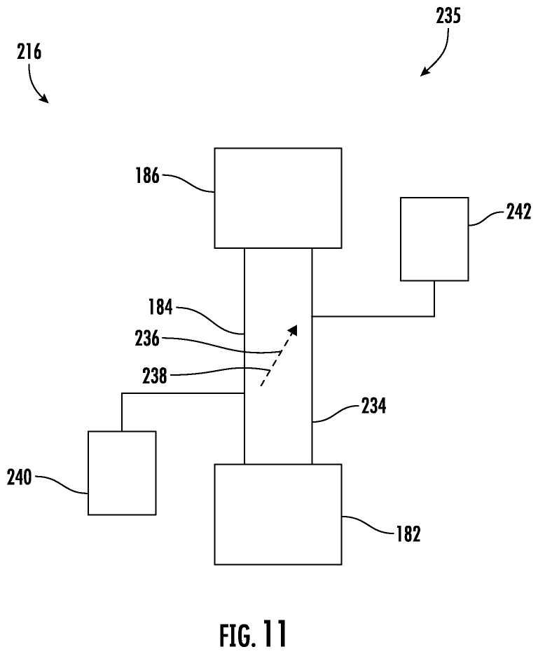

Turning now to FIG. 11, an embodiment is illustrated of a multi-purpose RF communication system 216 which uses the waveguide 184 in a manner that is additional to its use as a waveguide between RF antennas associated with the RF transmitter 182 and RF receiver 186. The embodiment schematically depicted in FIG. 11 illustrates use of the waveguide 184 as a control bus 234 in a control signal transmission system 235. In the embodiment depicted in FIG. 11, the waveguide 184 can facilitate transmission of a control signal 236 that includes control data 238 indicative of a control process. The control signal 236 can be generated by a first control component 240, such as the controller 199, and transmitted, via the waveguide 184/control bus 234, to the second control component 242, such as an actuator that actuates position of the control effector 101. The control signal 236 can be transmitted at a different frequency than that of RF communication signal 192 so as not to create interference. It will be appreciated that FIG. 11 is merely a schematic representation of the interconnections between the first control component 240 and second control component 242, via the waveguide 184/control bus 234. The drawing in FIG. 11 is not intended to imply the location of physical connection of either the first control component 240 or second control component 242 to the waveguide 184/control bus 234.

In some forms, the waveguide 184/control bus 234 can act as a primary control path between first control component 240 and second control component 242. In other embodiments, however, the waveguide 184/control bus 234 can act as a redundant, or secondary, control path between first control component 240 and second control component 242. To set forth just one example, the waveguide 184/control bus 234 can receive a backup control signal from the controller 199 for use with the control effector 101 in case of failure of a primary control path, such as a catastrophic mechanical failure associated with a wiring harness that carries control signals to an actuator that actuates position of the control effector 101. As appreciated from the discussion above, one or more other components may be intermediate either or both of the first control components 240 and the second control components 242 and the waveguide 184/control bus 234.

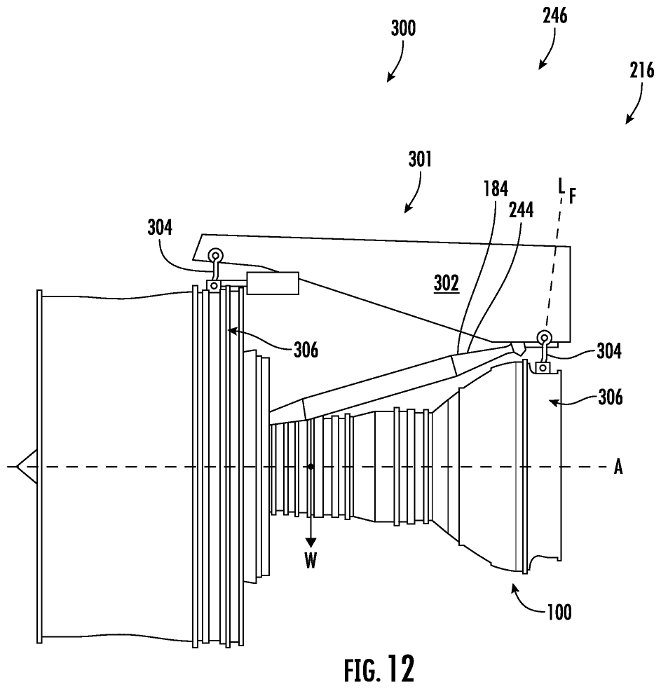

Turning now to FIG. 12, an embodiment is illustrated of a multi-purpose RF communication system 216 which uses the waveguide 184 in a manner that is additional to its use as a waveguide between RF antennas associated with the RF transmitter 182 and RF receiver 186. The embodiment depicted in FIG. 12 illustrates use of the waveguide 184 integrated into an engine-mounting linkage systems 300. FIG. 12 shows the gas turbine engine 100 mounted to an engine support structure 302 of an aircraft 10. The engine-mounting linkage systems 300 can be used to mount an aircraft engine (e.g., the gas turbine engine 100) to an engine support structure 302, providing an engine assembly 301 secured to an aircraft 10. The engine-mounting linkage system 300 can include one or more engine-mounting links 304 configured to couple an engine frame 306 to an engine support structure 302 of the aircraft 10. The embodiment depicted in FIG. 12 further illustrates use of the waveguide 184 as an engine support 244 in aircraft structural support system 246. The waveguide 184/engine support 244 extends between the engine support structure 302 and gas turbine engine 100 and provides structural support for the gas turbine engine 100. Failure of any of the engine-mounting links 304 or waveguide 184/engine support 244 will cause structural failure of the aircraft in a manner that renders the aircraft unairworthy and/or weakens and/or causes failure of flight critical hardware. Though the waveguide 184 is illustrated as an engine support 244 in FIG. 12, the waveguide 184 can be used for other aircraft structure whether or not related to the powerplant 1001. For example, the waveguide 184 can be used for a vehicle structure, such as a wing spar, rib, landing gear linkage, etc.

Embodiments of any one of the multi-purpose RF communication systems 216 depicted in FIGS. 9-12 can be coupled with one or more of the other embodiments of the multi-purpose RF communication system 216 depicted in FIGS. 9-12. To set forth just a few non-limiting examples of the various combinations possible in FIGS. 9-12, use of the waveguide 184 as part of a heat exchange fluid circuit 218 of FIG. 9 can be combined with use of the waveguide 184 as the power bus 226 of FIG. 10. Additionally, in one form, the aforementioned combined use of the waveguide 184 can be further combined with use of the waveguide 184 as the engine support 244. Alternatively and/or additionally to these aforementioned combinations, the waveguide 184 can be used as both power bus (FIG. 11) and control bus (FIG. 10) akin to form a power-line communication combination where data can be transferred over a power line/power bus. In this embodiment, the control signal 236, RF communication signal 192, and power over the power bus can be at different frequencies so as not to create interference. Any variety of other combinations are also contemplated.

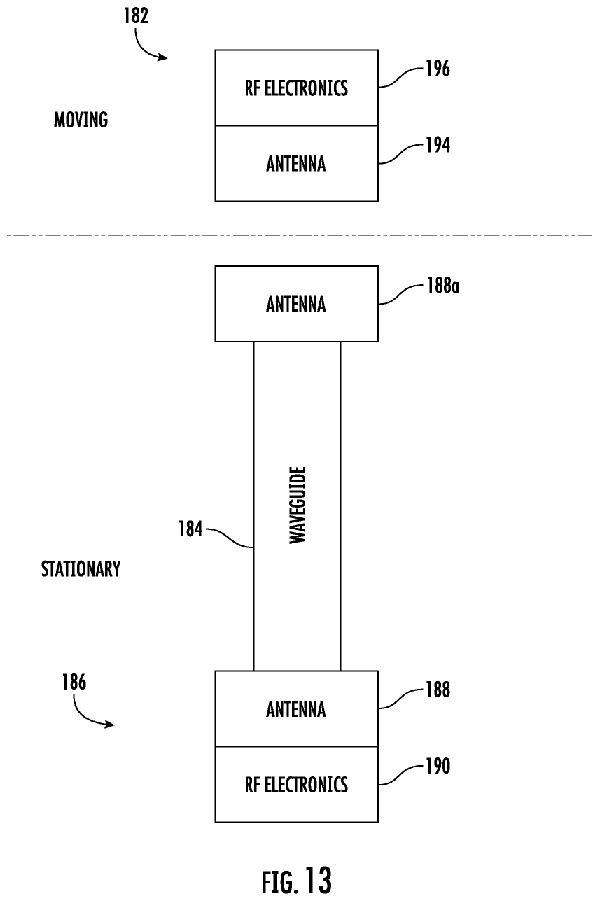

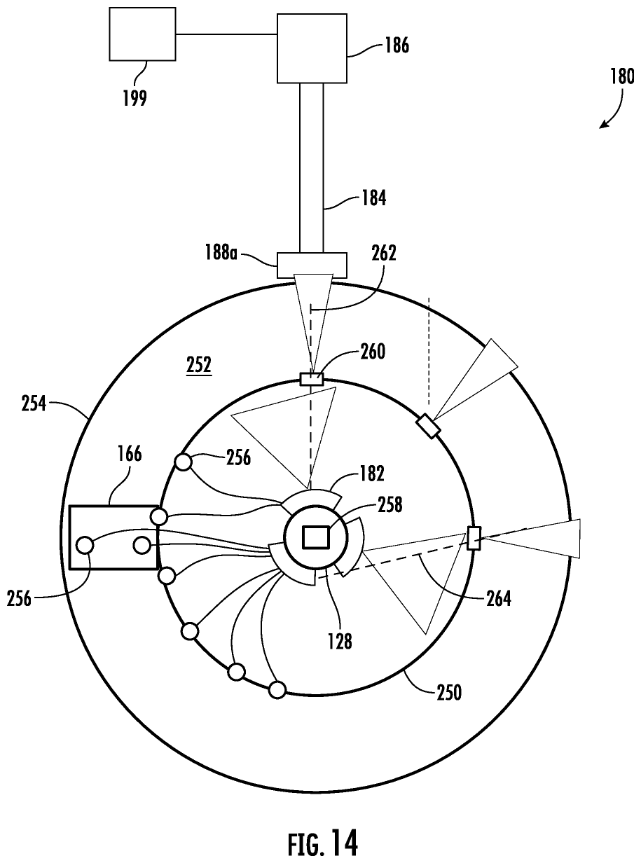

In some embodiments of the present disclosure, such as those of FIGS. 9-12, the RF antenna 188 may be coupled to remain in position relative to the waveguide 184. In other embodiments, however, the RF antenna 188 may move relative to the waveguide 184. Turning now to FIGS. 13 and 14, embodiments are depicted of the RF communication system 180 which include components coupled to move relative to other components of the RF communication system 180. The embodiments depicted in FIGS. 13 and 14 can be referred to as a data transfer system, much as the embodiment depicted in FIGS. 3 and 4, and FIG. 11, can also be referred to as a data transfer systems. In both embodiments, the RF receiver 186 and waveguide 184 remain stationary relative to a moving RF transmitter 182. In the embodiments of FIGS. 13 and 14, the waveguide is also electromagnetically coupled with a RF antenna 188a structured to receive transmission from the moving RF transmitter 182. In some embodiments, a RF electronics can also be used with the RF transmitter 182, as in the use of RF electronics 190 and RF antenna 188 of RF receiver 186. By nature of the electromagnetically coupled waveguide 184 and RF antenna 188a, the RF communication signal 192 can be conveyed through the waveguide 184 to the RF receiver 186. Given that antennas may have an antenna pattern which is often non-uniform, and given that orientation of the RF antenna 194 relative to the RF antenna 188a may change, the RF antenna 188a can receive the RF communication signal 192 at varying signal-to-noise ratios depending upon the relative location and orientation of RF antenna 194 and RF antenna 188a. Further, if relative movement of the RF antenna 194 and RF antenna 188a cause obstacles to interfere with reception of the RF communication signal 192 from the RF transmitter 182, the RF antenna 188a may not receive the RF communication signal 192, or may receive the RF communication signal 192 at such low signal-to-noise ratio as to render the data 193 unusable or unreliable.

FIG. 14 illustrates an embodiment in which the RF transmitter 182 is mounted to a rotating component of the gas turbine engine 100 in the form of HP shaft 128. The gas turbine engine 100 can be installed on a vehicles such as an aircraft, or can be installed in a stationary setting such as a power plant, or as a test rig. In other forms, the RF transmitter 182 can be coupled to rotate with LP shaft 130, or any other rotating component of the gas turbine engine 100, such as a disc, blade root, etc. Three RF transmitters 182 are coupled to the LP shaft 130, but fewer or greater numbers of RF transmitters 182 can be used in other embodiments. Furthermore, the RF transmitters 182 can be placed at locations other than on the HP shaft 128 which also rotate with the HP shaft 128. The HP shaft 128 can be coupled with an inner flow surface 250 from which HP turbine rotor blades 166 extend. Although the illustrated embodiment in FIG. 14 is directed to the HP turbine, other sections of the gas turbine engine 100 are also contemplated herein. The HP turbine rotor blades 166 are configured to rotate with the HP shaft 128 in an annular flow path 252 defined between the inner flow surface 250 and outer flow surface 254. As will be appreciated, the outer flow surface 254 is stationary.

The gas turbine engine 100, including but not limited to the HP turbine rotor blades 166, can be instrumented with a variety of sensors 256 which can be coupled, via a wired connection, to one or more RF transmitters 182. The sensors 256 can be coupled to any variety of rotatable turbomachinery components such as the HP turbine rotor blades 166, HP shaft 128, etc.). Data collected from the sensors 256 can be sampled and conveyed to the RF transmitter 182 before the data is encoded to an RF communication signal 192 and transmitted to the RF antenna 188a. The RF communication signal 192 can thereafter be transmitted through the waveguide 184 to the RF receiver 186.

A data acquisition unit 258 can be used to collect data from sensors 256 and communicate the collected data to the RF transmitters 182. As such, although FIG. 14 depicts wired connections between the sensors 256 and RF transmitter 182, it will be appreciated that in some embodiments the wired connections can be from the sensors 256, to the data acquisition unit 258, and then wired connections from the data acquisition unit 258 to the RF transmitters 182. The data acquisition unit 258 can include a power source (e.g., a battery) to power the sensors 256 and any associated electronics (e.g., signal conditioning) that may be needed to sample the sensor 256 and provide a data useful for encoding into the RF communication signal 192. Thus, the data acquisition unit 258 can provide power and the data to the RF transmitter 182 for transmission to the RF receiver 186. The data acquisition unit 258, therefore, can include power and/or signal connections to the sensors 256, and power and/or signal connections to the RF transmitter 182.

The sensors 256 can take a variety of forms and can sample data at a variety of rates. In one form, the sensors 256 can output an analog data signal to the data acquisition unit 258, while in other forms, the sensors 256 may output a digital data signal. As mentioned above, any appropriate signal conditioning circuit can be used to format the signal for encoding into the RF communication signal 192. The sensors 256 can take the form of a pressure transducer, thermocouple, strain gage, and flow sensor. Other types are also contemplated herein. Given the wide variety of potential sensor types, and given that the system can include more than one sensor 256, the data acquisition unit 258 can include signal conditioning for each of the separate sensors 256 and/or separate sensor types.

The system depicted in FIG. 14 also includes RF apertures 260 disposed in the inner flow surface 250. The RF apertures can be made from a variety of materials that permit all, or a useful portion of, the RF communication signal 192 to pass therethrough such that transmission of the RF communication signal 192 by the RF transmitter 182 can be received by the RF antenna 188a. In one form, the RF aperture 260 is made of a non-conducting material and/or an RF transparent material. To set forth just one non-limiting example, the RF aperture 260 can be made of a high temperature glass.

The RF apertures 260 can be in circumferential alignment with the RF transmitter 182 such that an unobstructed radial line can be drawn from a surface of the RF transmitter 182 through the RF aperture 260. An example of this can be seen in dashed line 262. In some embodiments, however, the RF apertures 260 may not be in circumferential alignment. Relative circumferential placement of the RF transmitter 182, and specifically the RF antenna 194, with any given RF aperture 260 may be made on the basis of the antenna pattern particular to any given RF antenna 194. For example, if the RF antenna 194 includes side lobes (e.g., a lobe on a lateral side of the RF antenna 194) having greater power density, the RF aperture 260 may be circumferentially aligned with the side lobe to provide greatest transmission power through the RF aperture 260. An example of this can be seen in dashed line 264. Additionally and/or alternatively, the RF aperture 260 may be aligned axially with an associated RF transmitter 182 so as to permit a greater power of RF communication signal 192 to be passed through the RF aperture 260. Relative axial placement of the RF transmitter 182, and specifically the RF antenna 194, with the RF aperture 260 may be made on the basis of the antenna pattern particular to any given RF antenna 194. For example, if the RF antenna 194 includes side lobes having greater power density, the RF aperture 260 may be axially aligned with the side lobe to provide greatest transmission power through the RF aperture 260. Any number of RF apertures 260 can be used in any given embodiment.

As will be appreciated given the discussion above, the RF aperture 260 may permit passage of RF communication signal 192 from any of a variety of RF transmitters placed at any variety of locations. Given the rotating nature of the RF transmitters 182 and RF apertures 260, the strength of the RF communication signal 192 (e.g., as measured by signal-to-noise ratio) can vary as a function of the rotational position to the waveguide 184. Such varying strength of the RF communication signal 192 can create an intermittent RF communication signal 192 received by the RF antenna 188a. During some portions of operation of the gas turbine engine 100, the intermittent reception to the RF antenna 188a, and subsequent reception to the RF receiver 186 via the waveguide 184, may be periodic.

The controller 199 can be coupled to the RF receiver 186 and be structured to extract the data from the RF communication signal 192. The data extracted can be recorded as a function of the time to create a time history. Relevant additional information associated with the RF communication signal 192 having the data can also be recorded, such as an identifier of the RF transmitter 182 responsible for the communication. If the RF communication signal 192 is able to be received by the RF antenna 188a in sufficient strength over only an intermittent window of time, the controller 199 can record the data encoded in the RF communication signal 192 over the intermittent window of time. The data can be sampled at a sample rate by the controller 199, in which each sample of data is given an associated time that it is collected. Thus, a time history over the intermittent window of time can be recorded for any given data associated with any given sensor 256 that is transmitted by any given RF transmitter 182. In the case of high rate data sampling from a sensor having high rate, the controller 199 may be configured to down sample the data to a lower rate, or, in some forms, the clock rate of the controller 199 may naturally result in a down sampling.

Embodiments of any one or more of the multi-purpose RF communication systems 216 depicted in FIGS. 9-12 can be coupled with the embodiment of the RF communication system 180 depicted in FIGS. 13 and 14. To set forth just a few non-limiting examples, use of the waveguide 184 as part of structural support in FIG. 12 can be combined with use of the waveguide 184 as an RF communication system illustrated in FIG. 14. Alternatively and/or additionally, the waveguide 184 of the RF communication system 180 can be used as both power bus (FIG. 11) and control bus (FIG. 10) akin to form a power-line communication combination where data can be transferred over a power line/power bus. Other combinations are also contemplated.

Any of the embodiments of controller 199 can be implemented in a distributed computing environment in which the one or more actions exist on different physical machines. In some embodiments, the components of the controller 199 can be hosted on one or more cloud computing services or a hybrid cloud/local computing system.

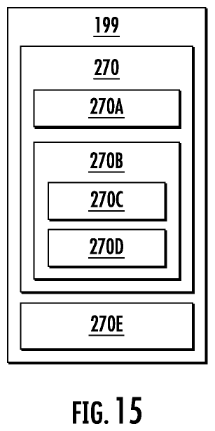

Turning now to FIG. 15, one or more portions of the controller 199 can be implemented using a computing device 270, one embodiment of which is illustrated in FIG. 15. The computing device(s) 270 can include one or more processor(s) 270A and one or more memory device(s) 270B. The one or more processor(s) 270A can include any suitable processing device, such as a microprocessor, microcontroller, integrated circuit, logic device, and/or other suitable processing device. The one or more memory device(s) 270B can include one or more computer-readable media, including, but not limited to, non-transitory computer-readable media, RAM, ROM, hard drives, flash drives, and/or other memory devices.

The one or more memory device(s) 270B can store information accessible by the one or more processor(s) 270A, including computer-readable instructions 270C that can be executed by the one or more processor(s) 270A. The instructions 270C can be any set of instructions that when executed by the one or more processor(s) 270A, cause the one or more processor(s) 270A to perform operations. In some embodiments, the instructions 270C can be executed by the one or more processor(s) 270A to cause the one or more processor(s) 270A to perform operations, such as any of the operations and functions for which the information system and/or the computing device(s) 270 are configured. The instructions 270C can be software written in any suitable programming language or can be implemented in hardware. Additionally, and/or alternatively, the instructions 270C can be executed in logically and/or virtually separate threads on the one or more processor(s) 270A. The one or more memory device(s) 270B can further store data 270D that can be accessed by the one or more processor(s) 270A.

The computing device(s) 270 can also include a network interface 270E used to communicate, for example, with the other components of the systems described herein (e.g., via a communication network). The network interface 270E can include any suitable components for interfacing with one or more network(s), including for example, transmitters, receivers, ports, controllers, antennas, and/or other suitable components. One or more devices can be configured to receive one or more commands from the computing device(s) 270 or provide one or more commands to the computing device(s) 270.

The network interface 270E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

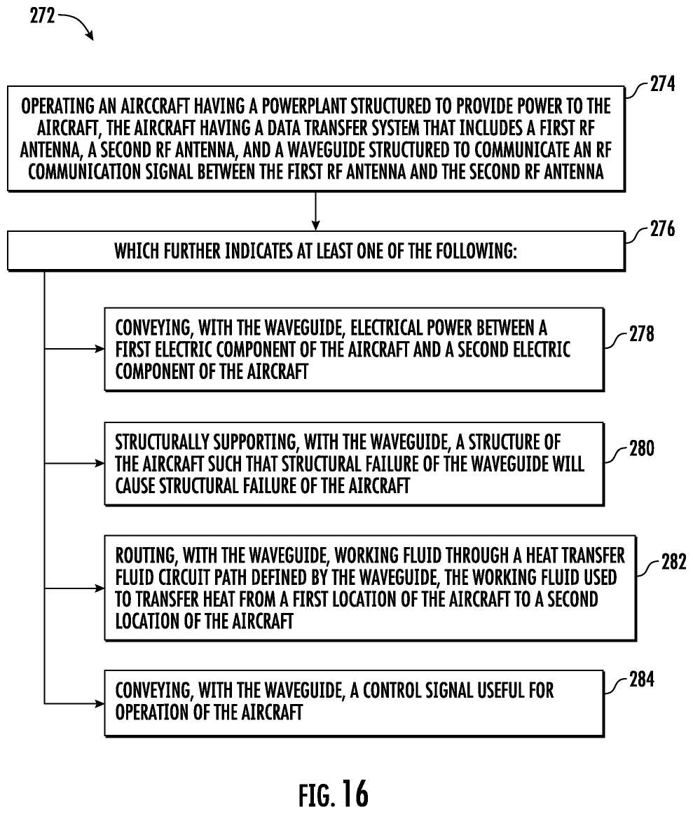

FIG. 16 discloses a method 272 for transmitting data from a rotatable sensor 256 of the present disclosure. The method 272 includes, at step 274, operating an aircraft 10 having a powerplant 1001 structured to provide power to the aircraft 10, the aircraft 10 having a data transfer system that includes a first RF antenna 188, a second RF antenna 194, and a waveguide 184 structured to communicate an RF communication signal 192 between the first RF antenna 188 and the second RF antenna 194. The powerplant 1001 can be a gas turbine engine 100 in some embodiments. The first RF antenna 188 can be associated with either an RF transmitter 182 or an RF receiver 186. In some forms, the first RF antenna 188 can be a transceiver. The second RF antenna 194 can be associated with either an RF transmitter 182 or an RF receiver 186. In some forms, the first RF antenna 188 can be a transceiver. The waveguide 184 can take on any form of the embodiments disclosed above in FIGS. 4-14.

Step 276 sets forth the method 272 can also include one or more additional steps 278-284. Step 278 includes conveying, with the waveguide 184, electrical power between a first electrical component 228 of the aircraft 10 and a second electrical component 230 of the aircraft 10. The waveguide 184 can provide power as a direct current or alternating current.

Step 280 includes structurally supporting, with the waveguide 184, a structure of the aircraft such that structural failure of the waveguide 184 will cause structural failure of the aircraft 10. The waveguide 184 can take the form of an engine support 244 which is used to support the gas turbine engine 100. Failure of the waveguide 184/engine support 244 will cause structural failure of the aircraft in a manner that renders the aircraft unairworthy and/or weakens and/or causes failure of flight critical hardware.

Step 282 includes routing, with the waveguide 184, working fluid 220 through a heat transfer fluid circuit path defined by the waveguide 184, the working fluid 220 used to transfer heat from a first location of the aircraft (e.g., an evaporator of a refrigeration cycle) to a second location of the aircraft 10 (e.g., a condenser of a refrigeration cycle). The heat transfer fluid circuit path can be an open loop or a closed loop system. In one form, the working fluid 220 is routed through one or more conduits 222 in either the open loop or closed loop system.

Step 284 includes conveying, with the waveguide 184, a control signal 236 useful for operation of the aircraft 10. The control signal 236 can be used to control a control effector 101, such as a rudder or elevator of the aircraft 10. The control signal 236 can be used to activate an actuator structured to move the control effector 101.

The method 272 can include additional steps beyond those depicted in FIG. 16. In one embodiment, the method 272 can also include conveying electrical power from a power generation source 227 via the waveguide 184 to an electrical component, such as a first electrical component 228. Alternatively and/or additionally, the method 272 can include routing the working fluid 220 through a conduit 222 as part of the heat transfer fluid circuit path. Alternatively and/or additionally, the method 272 can include transmitting a sensor data through an RF aperture 260, the RF aperture coupled to rotate with a rotatable turbomachinery component, such as HP shaft 128.

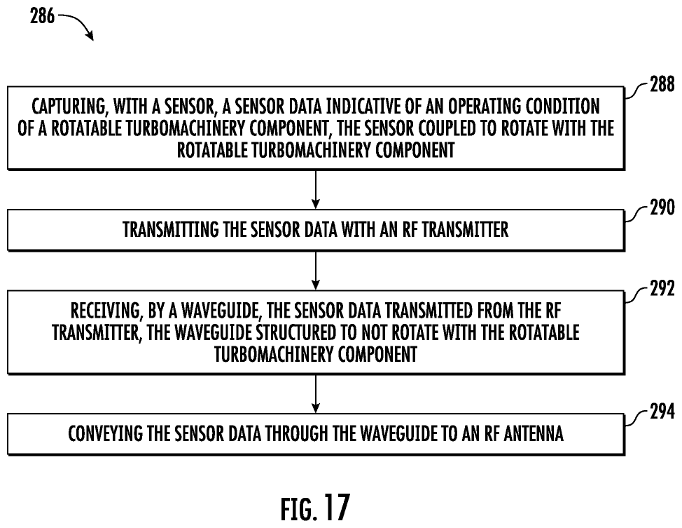

FIG. 17 discloses a method 286 for transmitting data. The method 286 includes, at step 288, capturing, with a sensor 256, a sensor data indicative of an operating condition of a rotatable turbomachinery component (e.g., the HP turbine rotor blades 166, HP shaft 128, etc.), the sensor 256 coupled to rotate with the rotatable turbomachinery component (e.g., the HP turbine rotor blades 166, HP shaft 128, etc.). Step 290 sets forth that the method 286 can also include transmitting the sensor data with an RF transmitter 182. In some forms, the RF transmitter 182 can be a transceiver, as set forth above. Step 292 of method 286 sets forth receiving, by a waveguide 184, the sensor data transmitted from the RF transmitter 182, the waveguide 184 structured to not rotate with the rotatable turbomachinery component (e.g., the HP turbine rotor blades 166, HP shaft 128, etc.). Step 294 includes conveying the sensor data through the waveguide 184 to an RF antenna 194. The RF antenna 194 can be associated with an RF receiver 186. In some forms, the RF receiver 186 can be a transceiver. Other steps are also contemplated with the method 286, including transmitting the sensor data through an RF aperture 260, the RF aperture 260 coupled to rotate with the rotatable turbomachinery component (e.g., the HP turbine rotor blades 166, HP shaft 128, etc.). The method 286 can also include conveying, with the waveguide 184, electrical power between a first electrical component 228 and a second electrical component 230. Alternatively and/or additionally, the method 286 can also include structurally supporting, with the waveguide 184, a structure of an aircraft 10 such that structural failure of the waveguide 184 will cause structural failure of the aircraft. Alternatively and/or additionally, the method 286 can also include routing, with the waveguide 184, working fluid 220 through a heat transfer fluid circuit path defined by the waveguide 184. Alternatively and/or additionally, the method 286 can also include conveying, with the waveguide 184, a control signal 236 useful for operation of the aircraft 10. The control signal 236 can be useful for operation of the aircraft 10 in an embodiment in which the control signal 236 is used to control a control effector 101. For example, if the control effector 101 is a rudder, elevator, or other control surface of the aircraft 10, the control signal 236 can be used to drive an actuator useful to control a position of the control surface.

A technical benefit of the RF communication system 180 is a more efficient use of structure associated with the RF communication system 180 and/or more versatile system by which data can be captured and routed. For example, by using a waveguide 184 for multiple purposes (e.g., a path for working fluid, a power bus, a control bus, or a structural support), fewer components need be used in the aircraft 10 resulting in reduced weight and increased efficiency and/or performance. Data can also be collected in rotating objects and reliably conveyed with minimal latency to a stationary antenna capable of receiving an RF communication signal 192.

Further aspects are provided by the subject matter of the following clauses:

An aircraft system, comprising: an aircraft having a powerplant structured to provide power to the aircraft; an RF antenna coupled to the aircraft; a waveguide structured to transfer an RF communication signal, the waveguide coupled to the RF antenna; and wherein the waveguide is also structured as one or more of the following: (1) an electrical power bus configured to convey electrical power between electric components; (2) a structural member of a support structure of the aircraft configured such that structural failure of the waveguide will cause structural failure of the aircraft; (3) a heat transfer fluid circuit path configured to convey a working fluid for a heat transfer system; and (4) a control path configured to convey a control signal for operation of the aircraft.

The aircraft system of the preceding clause, wherein the electrical power bus conveys either a direct current (DC) electrical power or an alternating current (AC) electrical power between electric components.

The aircraft system of any preceding clause, wherein the electrical power bus is coupled with a power generation source.

The aircraft system of any preceding clause, wherein the power generation source is an electric generator powered by the powerplant of the aircraft.

The aircraft system of any preceding clause, wherein the support structure is an engine support, the engine support providing structural support for the powerplant.

The aircraft system of any preceding clause, wherein the heat transfer fluid circuit path occupies at least a portion of a length of the waveguide between a proximal end of the waveguide and a distal end of the waveguide.

The aircraft system of any preceding clause, wherein the heat transfer fluid circuit path conveys a heat transfer fluid in a refrigeration circuit.

The aircraft system of any preceding clause, wherein the heat transfer fluid circuit path includes at least one branch.

The aircraft system of any preceding clause, wherein the heat transfer fluid circuit path includes an annular space.

The aircraft system of any preceding clause, wherein the heat transfer fluid circuit path includes a plurality of interior spaces.

The aircraft system of any preceding clause, wherein the control signal conveyed by the control path is in a form of an electrical signal having a spectral content at different frequency than a spectral content of the RF communication signal.

The aircraft system of any preceding clause, wherein the control signal includes control data indicative of a control process.

The aircraft system of any preceding clause, wherein the control process includes a control signal configured to regulate a control effector of the aircraft to provide a control force and/or moment to manipulate aircraft dynamics during operation of the aircraft.

The aircraft system of any preceding clause, wherein the powerplant is a gas turbine engine having a rotatable turbomachinery component, further comprising a sensor coupled to rotate with the rotatable turbomachinery component and structured to generate sensor data indicative of a turbomachinery condition, further comprising an RF transmitter coupled to the rotatable turbomachinery component and structured to receive the sensor data from the sensor, wherein the RF antenna is coupled with the waveguide and structured to receive the sensor data conveyed through the waveguide from the RF transmitter.

The aircraft system of any preceding clause, wherein the RF transmitter is a 5G transmitter configured to transmit the RF communication signal at a frequency between 700 MHz and 66 GHz.

The aircraft system of any preceding clause, further comprising an RF aperture positioned between the RF transmitter and RF receiver, the RF aperture formed of a material to permit RF transmission therethrough of the RF communication signal transmitted from the RF transmitter.

The aircraft system of any preceding clause, wherein the RF aperture is located in an annular wall of the rotatable turbomachinery component.

The aircraft system of any preceding clause, wherein the annular wall is an inner flow surface.

The aircraft system of any preceding clause, wherein the sensor is coupled to a blade of the rotatable turbomachinery component.

A method for transmitting data, comprising: operating an aircraft having a powerplant structured to provide power to the aircraft, the aircraft having a data transfer system that includes a first RF antenna, a second RF antenna, and a waveguide structured to communicate an RF communication signal between the first RF antenna and the second RF antenna; and completing at least one of the following: conveying, with the waveguide, an electrical power between a first electric component of the aircraft and a second electric component of the aircraft; structurally supporting, with the waveguide, a structure of the aircraft such that structural failure of the waveguide will cause structural failure of the aircraft; routing, with the waveguide, a working fluid through a heat transfer fluid circuit path defined by the waveguide, the working fluid used to transfer heat from a first location of the aircraft to a second location of the aircraft; and conveying, with the waveguide, a control signal useful for operation of the aircraft.

The method of the preceding clause, wherein the powerplant is configured to provide mechanical rotational power to a power generation source, and wherein the conveying electrical power includes conveying electrical power from the power generation source to an electrical component.

The method of any preceding clause, wherein the heat transfer fluid circuit path is further defined by a conduit in fluid communication with the waveguide, and wherein the routing also includes routing the working fluid through the conduit.

The method of any preceding clause, wherein the waveguide is in a form of an engine support member coupling the powerplant to the aircraft such that a structural failure of the waveguide causes structural failure of an attachment of the powerplant to the aircraft.

The method of any preceding clause, wherein the powerplant includes a gas turbine engine having a rotatable turbomachinery component, and further comprising transmitting a sensor data through an aperture, the aperture coupled to rotate with the rotatable turbomachinery component.

A data transfer system, comprising: a rotatable turbomachinery component configured to rotate about a rotational axis during operation of the rotatable turbomachinery component; a sensor coupled with the rotatable turbomachinery component and structured to generate sensor data indicative of a turbomachinery condition; an RF transmitter coupled to rotate with the rotatable turbomachinery component and structured to receive the sensor data from the sensor, the RF transmitter further structured to transmit an RF communication signal that includes the sensor data; a waveguide positioned exterior of the rotatable turbomachinery component such that the rotatable turbomachinery component rotates relative to the waveguide, the waveguide oriented to receive the sensor data transmitted from the RF transmitter; and an RF receiver coupled with the waveguide and structured to receive the sensor data conveyed through the waveguide from the RF transmitter.

The data transfer system of the preceding clause, wherein the RF receiver is coupled with the waveguide and structured to receive the sensor data conveyed through the waveguide from the RF transmitter.

The data transfer system of any preceding clause, wherein the RF transmitter is a 5G transmitter configured to transmit the RF communication signal at a frequency between 700 MHz and 66 GHz.

The data transfer system of any preceding clause, further comprising an RF aperture positioned between the RF transmitter and the RF receiver, the RF aperture formed of a material to permit RF transmission therethrough of the RF communication signal transmitted from the RF transmitter.

The data transfer system of any preceding clause, wherein the RF aperture is located in an annular wall of the rotatable turbomachinery component.

The data transfer system of any preceding clause, further comprising a plurality of RF apertures circumferentially spaced in the annular wall.

The data transfer system of any preceding clause, wherein the RF transmitter is circumferentially positioned coincident with the RF aperture.

The data transfer system of any preceding clause, wherein the RF transmitter is positioned on a shaft of gas turbine engine.

The data transfer system of any preceding clause, wherein the sensor is coupled to a blade of the rotatable turbomachinery component.

The data transfer system of any preceding clause, wherein the sensor comprises at least one of a pressure transducer, a thermocouple, a vibration sensor, or a strain gauge.

A data transfer system, comprising: a rotatable turbomachinery component configured to rotate about a rotational axis during operation of the rotatable turbomachinery component, the rotatable turbomachinery component having an outer housing with an opening into which is inserted an RF aperture; a first RF antenna coupled to the rotatable turbomachinery component and structured to rotate with the rotatable turbomachinery component; a second RF antenna positioned external to the rotatable turbomachinery component and structured such that it does not rotate with the rotatable turbomachinery component; and a waveguide positioned external to the rotatable turbomachinery component, the waveguide structured to communicate an RF communication signal between the first RF antenna and the second RF antenna.

The data transfer system of the preceding clause, further comprising a controller structured to receive the RF communication signal, wherein the controller is structured to record a time stamp associated with a reception of the RF communication signal.

The data transfer system of any preceding clause, wherein the waveguide is positioned radially outward of the rotatable turbomachinery component.

The data transfer system of any preceding clause, further comprising a plurality of waveguides distributed circumferentially around the rotatable turbomachinery component.

The data transfer system of any preceding clause, wherein the waveguide is configured as an electrical power bus and structured to convey electrical power between a first electric component and a second electrical component.

The data transfer system of any preceding clause, wherein the rotatable turbomachinery component is coupled to a support structure, wherein the waveguide is configured to carry loads as a structural member of the support structure such that structural failure of the waveguide will cause structural failure of the support structure.

The data transfer system of any preceding clause, wherein the waveguide includes an open interior configured to convey a working fluid, the open interior forming part of a heat transfer fluid circuit path of a heat transfer system.

The data transfer system of any preceding clause, wherein the rotatable turbomachinery component is integrated in a gas turbine engine, and wherein the waveguide is configured to convey a control signal useful for operation of the gas turbine engine.

A method for transmitting data, comprising: capturing, with a sensor, a sensor data indicative of an operating condition of a rotatable turbomachinery component, the sensor coupled to rotate with the rotatable turbomachinery component; transmitting the sensor data with a RF transmitter; receiving, by a waveguide, the sensor data transmitted from the RF transmitter, the waveguide structured to not rotate with the rotatable turbomachinery component; and conveying the sensor data through the waveguide to an RF antenna.

The method of the preceding clause, wherein the transmitting includes transmitting the sensor data through an RF aperture, the RF aperture coupled to rotate with the rotatable turbomachinery component.

The method of any preceding clause, further comprising at least one of the following: conveying, with the waveguide, electrical power between a first electric component and a second electric component; structurally supporting, with the waveguide, a structure of an aircraft such that structural failure of the waveguide will cause structural failure of the aircraft; routing, with the waveguide, working fluid through a heat transfer fluid circuit path defined by the waveguide; and conveying, with the waveguide, a control signal useful for operation of the aircraft.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. An aircraft system, comprising:
an aircraft having a powerplant structured to provide power to the aircraft;
an RF antenna coupled to the aircraft;
a waveguide structured to transfer an RF communication signal, the waveguide coupled to the RF antenna; and
wherein the waveguide is also structured as one or more of the following: (1) an electrical power bus configured to convey electrical power between electric components; (2) a structural member of a support structure of the aircraft configured such that structural failure of the waveguide will cause structural failure of the aircraft; (3) a heat transfer fluid circuit path configured to convey a working fluid for a heat transfer system; and (4) a control path configured to convey a control signal for operation of the aircraft.

2. The aircraft system of claim 1, wherein the electrical power bus conveys either a direct current (DC) electrical power or an alternating current (AC) electrical power between electric components.

3. The aircraft system of claim 1, wherein the electrical power bus is coupled with a power generation source.

4. The aircraft system of claim 3, wherein the power generation source is an electric generator powered by the powerplant of the aircraft.

5. The aircraft system of claim 1, wherein the support structure is an engine support, the engine support providing structural support for the powerplant.

6. The aircraft system of claim 1, wherein the heat transfer fluid circuit path occupies at least a portion of a length of the waveguide between a proximal end of the waveguide and a distal end of the waveguide.

7. The aircraft system of claim 1, wherein the heat transfer fluid circuit path conveys a heat transfer fluid in a refrigeration circuit.

8. The aircraft system of claim 1, wherein the control signal conveyed by the control path is in a form of an electrical signal having a spectral content at different frequency than a spectral content of the RF communication signal.

9. The aircraft system of claim 1, wherein the control signal includes control data indicative of a control process.

10. The aircraft system of claim 9, wherein the control process includes a control signal configured to regulate a control effector of the aircraft to provide a control force and/or moment to manipulate aircraft dynamics during operation of the aircraft.

11. The aircraft system of claim 1, wherein the powerplant is a gas turbine engine having a rotatable turbomachinery component, further comprising a sensor coupled to rotate with the rotatable turbomachinery component and structured to generate sensor data indicative of a turbomachinery condition, further comprising an RF transmitter coupled to the rotatable turbomachinery component and structured to receive the sensor data from the sensor, wherein the RF antenna is coupled with the waveguide and structured to receive the sensor data conveyed through the waveguide from the RF transmitter.

12. The aircraft system of claim 11, wherein the RF transmitter is a 5G transmitter configured to transmit the RF communication signal at a frequency between 700 MHz and 66 GHz.

13. The aircraft system of claim 11, further comprising an RF aperture positioned between the RF transmitter and RF receiver, the RF aperture formed of a material to permit RF transmission therethrough of the RF communication signal transmitted from the RF transmitter.

14. The aircraft system of claim 13, wherein the RF aperture is located in an annular wall of the rotatable turbomachinery component.

15. The aircraft system of claim 11, wherein the sensor is coupled to a blade of the rotatable turbomachinery component.

16. A method for transmitting data, comprising:
operating an aircraft having a powerplant structured to provide power to the aircraft, the aircraft having a data transfer system that includes a first RF antenna, a second RF antenna, and a waveguide structured to communicate an RF communication signal between the first RF antenna and the second RF antenna; and
completing at least one of the following:
conveying, with the waveguide, an electrical power between a first electric component of the aircraft and a second electric component of the aircraft;
structurally supporting, with the waveguide, a structure of the aircraft such that structural failure of the waveguide will cause structural failure of the aircraft;
routing, with the waveguide, a working fluid through a heat transfer fluid circuit path defined by the waveguide, the working fluid used to transfer heat from a first location of the aircraft to a second location of the aircraft; and
conveying, with the waveguide, a control signal useful for operation of the aircraft.

17. The method of claim 16, wherein the powerplant is configured to provide mechanical rotational power to a power generation source, and wherein the conveying electrical power includes conveying electrical power from the power generation source to an electrical component.

18. The method of claim 16, wherein the heat transfer fluid circuit path is further defined by a conduit in fluid communication with the waveguide, and wherein the routing also includes routing the working fluid through the conduit.

19. The method of claim 16, wherein the waveguide is in a form of an engine support member coupling the powerplant to the aircraft such that a structural failure of the waveguide causes structural failure of an attachment of the powerplant to the aircraft.

20. The method of claim 16, wherein the powerplant includes a gas turbine engine having a rotatable turbomachinery component, and further comprising transmitting a sensor data through an aperture, the aperture coupled to rotate with the rotatable turbomachinery component.
